(19) United States
(12) Patent Application Publication
(10) Pub. No.: US 2023/0202150 A1
(43) Pub. Date: Jun. 29, 2023

(54) CHARGING MEMBER WITH COATING LAYER

(71) Applicant: HEWLETT-PACKARD DEVELOPMENT COMPANY, L.P., Spring, TX (US)

(72) Inventors: Noriaki KURODA, Yokohama, Kanagawa (JP); Toru OZAWA, Yokohama, Kanagawa (JP)

(73) Assignee: HEWLETT-PACKARD DEVELOPMENT COMPANY, L.P., Spring, TX (US)

(21) Appl. No.: 17/927,595

(22) PCT Filed: Jun. 2, 2021
(86) PCT No.: PCT/US2021/035436

§ 371 Date: Nov. 23, 2022

(30) Foreign Application Priority Data
Jun. 23, 2020 (JP) 2020-107903

(51) Int. Cl. B32B 25/08; G03G 15/02; B32B 27/28; B32B 27/18; B32B 25/16

(52) U.S. Cl. CPC B32B 25/08; G03G 15/0233; B32B 27/283; B32B 27/18; B32B 25/16; B32B 2255/102; B32B 2255/26; B32B 2457/00; B32B 2250/02; B32B 2038/0052

(57) ABSTRACT

A charging member, including: a conductive support; and a conductive body mounted on the conductive support, in which the conductive body includes an elastic layer located on the conductive support, a resin layer located on the elastic layer, and a coating layer located on the resin layer to form an outermost surface of the conductive body, and the coating layer contains a polysiloxane compound having a molecular structure that includes an Si—O—Zr bond.

### BACKGROUND

Some image forming apparatuses include a photoreceptor, a charging device, an exposure device which forms an electrostatic latent image on the photoreceptor, a development device which applies a toner onto the electrostatic latent image to develop a toner image, and a transfer device to transfer the toner image formed on the photoreceptor to a transfer material, such as a printing material. The charging device includes a charging member to charge the photoreceptor.

### BRIEF DESCRIPTION OF DRAWINGS

FIG. 1 is a schematic cross-sectional view of an example charging member.

FIG. 2 is a schematic enlarged cross-sectional view illustrating a portion of an example conductive base forming the example charging member of FIG. 1.

FIG. 3 is another schematic enlarged cross-sectional view of the example conductive base forming the charging member of FIG. 1.

FIG. 4 is another schematic enlarged cross-sectional view of the example conductive base forming the charging member of FIG. 1.

### DETAILED DESCRIPTION

Hereinafter, examples of a charging member will be described with reference to the drawings. In the description based on the drawings, the same reference numerals will be applied to the same constituents or similar constituents having the same function, and the overlapping description may be omitted. In addition, the dimensional ratio of each constituent is not limited to the illustrated ratio.

Charging Member and Image Forming Apparatus

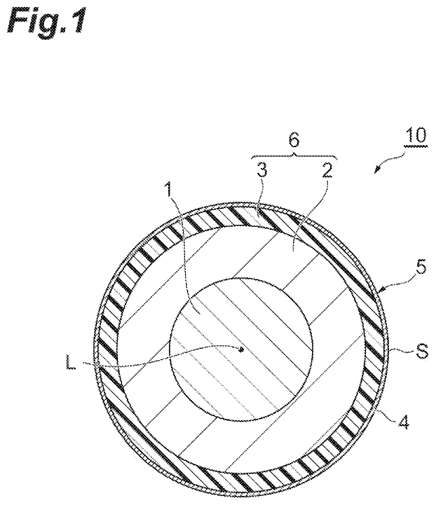

A charging member may include a conductive support and a conductive body mounted or formed on the conductive support. The conductive body includes an elastic layer located on the conductive support, a resin layer located on the elastic layer, and a coating layer located on the resin layer to form the outermost surface of the conductive body. Hereinafter, an example charging member 10 will be described with reference to FIG. 1.

The charging roller 10 (which forms a charging member) includes a conductive body 5. The conductive body 5 is in the shape of a roller to rotate about a rotation axis line L. The conductive body 5 is rotationally symmetric about the rotation axis line L. The charging roller 10 includes a conductive support 1 that provides a rotation axis for the conductive body 5. The conductive body 5 rotates about the rotation axis line L of the conductive support 1.

The conductive body 5 includes a conductive base 6 including an elastic layer having conductivity (or a conductive elastic layer) 2 that is in contact with the outer circumferential surface of the conductive support 1 and a resin layer having conductivity (or a conductive resin layer) 3 that is in contact with the outer circumferential surface of the elastic layer 2 , and a coating layer having insulating properties (or an insulating coating layer) 4 that is in contact with the outer circumferential surface of the resin layer 3. In some examples, the resin layer 3 may be formed around the elastic layer 2 with other layers interposed between the elastic layer 2 and the resin layer 3. For example, an interlayer such as a resistance adjustment layer for increasing voltage resistance (leakage resistance) may be interposed between the elastic layer 2 and the resin layer 3. In some examples, the coating layer 4 may be formed around the resin layer 3 with other layers interposed between the resin layer 3 and the coating layer 4 . However, in some examples, an oriented state of a polysiloxane compound (for example, a polysiloxane compound having a perfluoroalkyl group and a silicone structure) in the coating layer 4 described below may vary in accordance with a layer in contact with the coating layer 4 , and consequently, a physical state (an irregular state) and chemical properties (surface free energy or the like) of the outermost surface are changed. In some examples, the coating layer 4 is formed to be directly in contact with the outer circumferential surface of the resin layer 3, so as to more easily inhibit a contamination on the surface of the conductive body 5 due to the contact with the photoreceptor (for example, contamination due to an external additive).

Conductive Support

The conductive support 1 may be formed of a metal having conductivity. The conductive support 1, may be depending on examples, a hollow body (in the shape of a pipe, e.g., a circular tube), a solid body (in the shape of a rod), or the like, that may be formed of a metal including iron, copper, aluminum, nickel, stainless steel, and/or the like. The outer circumferential surface of the conductive support 1 may be subjected to a plating treatment, in order to impart rustproof or scratch resistance to the extent that the conductivity is not impaired. In addition, the outer circumferential surface of the conductive support 1 may be coated with an adhesive agent, a primer, or the like, in order to increase adhesiveness with respect to the elastic layer 2 . The adhesive agent, the primer, or the like may be selected to achieve sufficient conductivity.

The conductive support 1, according to examples, may be in the shape of a cylinder having a length of 250 mm to 360 mm. A portion of the conductive support 1 that is covered with the elastic layer 2 may be formed into the shape of a cylinder or a circular tube that extends along a rotation axis line L direction of the conductive support 1 (e.g., an extending direction or longitudinal direction of the conductive support 1), and may have a diameter (an outer diameter) that is constant along the rotation axis line L direction (in the shape of a cylinder or cylindrical tube). The diameter of the portion of the conductive support 1 that is covered with the elastic layer 2, for example, may be 8 mm to 10 mm.

A portion of the conductive support 1 that is not covered with the elastic layer 2, namely, the two end portions of the conductive support 1 are supported by a support member. The diameter of the portion of the conductive support 1 that is not covered with the elastic layer 2, for example, may be less than the diameter of the portion that is covered with the elastic layer 2. The conductive support 1 rotates about the rotation axis line (a center line of a cylinder) L of the conductive support 1, in a state of being supported on the support member.

The conductive support 1 is biased toward a photoreceptor such that the surface of the coating layer 4 is in contact with the surface of the photoreceptor. For example, in order to push the surface of the coating layer 4 against the surface of the photoreceptor, loads are applied to the end portions of the conductive support 1 toward the photoreceptor. From the viewpoint of allowing the charging roller 10 to suitably cohere with respect to a rotating photoreceptor, a bad applied to each end portion of the conductive support 1, may be 450 g to 750 g.

Elastic Layer

The elastic layer 2 may have suitable elasticity in order to achieve a uniform adhesiveness (or cohesiveness) with the photoreceptor. The elastic layer 2, for example, may be formed by using natural rubber; synthetic rubber such as ethylene-propylene-diene rubber (EPDM), styrene-butadiene rubber (SBR), silicone rubber, a polyurethane-based elastomer, epichlorohydrin rubber, isoprene rubber (IR), butadiene rubber (BR), acrylonitrile-butadiene rubber (NBR), hydrogenated NBR (H-NBR), and chloroprene rubber (CR); a synthetic resin such as a polyamide resin, a polyurethane resin, and a silicone resin; and the like, as a base polymer. Namely, the elastic layer 2 may include an elastic body containing such base polymers or cross-linked bodies thereof. Depending on examples, one type of the materials may be used, or two or more types thereof may be used in combination. From the viewpoint of uniform adhesiveness (cohesiveness) with the photoreceptor, the base polymer may contain a rubber component (natural rubber or synthetic rubber) as a main component. Namely, the base polymer may contain 50 mass % or more of the rubber component in some examples, or may contain 80 mass % or more of the rubber component in other examples.

In the base polymer, additives such as a conductive agent, a vulcanizing agent, a vulcanization promoter, a lubricant, and an auxiliary agent may be suitably compounded, in order to impart suitable properties to the elastic layer 2. However, from the viewpoint of forming stable resistance, the elastic layer 2 (the elastic body) may contain epichlorohydrin rubber and a cross-linked body thereof as a main component. Namely, the elastic layer 2 may contain 50 mass % or more of epichlorohydrin rubber or the cross-linked body thereof according to some examples, or may contain 80 mass % or more of epichlorohydrin rubber or the cross-linked body thereof according to other examples.

The conductive agent may include carbon black, graphite, potassium titanate, iron oxide, conductive titanium oxide (c-TiO₂), conductive zinc oxide (c-ZnO), conductive tin oxide (c-SnO₂), quaternary ammonium salt, and/or the like. Sulfur and/or the like, may be used as the vulcanizing agent. Tetramethyl thiuram disulfide (CZ) and/or the like, may be used as the vulcanization promoter. A stearic acid and/or the like, may be used as the lubricant. Zinc flower (ZnO) and/or the like, may be used as the auxiliary agent.

The thickness of the elastic layer 2 may be 1.25 mm to 3.00 mm, in order to exhibit suitable elasticity.

Resin Layer

The resin layer 3 contains a resin, and is a layer harder (for example, a layer having an elastic modulus measured based on Japanese Industrial Standard (JIS) K7162, that is greater) than the elastic layer. The resin layer 3 is formed on the elastic layer 2, in order to inhibit the bleeding of a plasticizer or the like from the elastic layer 2 to the surface of the conductive body 5.

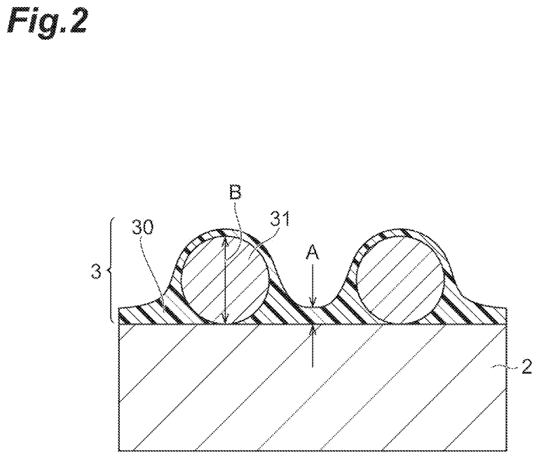

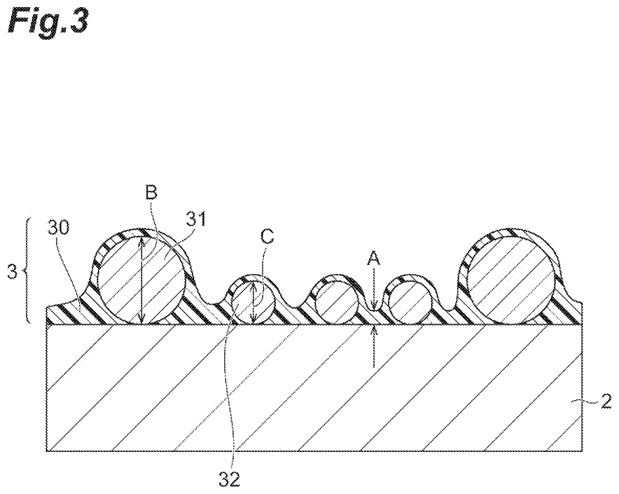

The resin layer 3, for example, may contain a matrix material, and particles dispersed in the material. The particles may include one type of particles in some examples, or may include two or more types of particles in other examples. For example, the resin layer 3, as illustrated in FIG. 2, may be a layer containing a matrix material 30, and first particles 31 dispersed in the material, or as illustrated in FIG. 3, may be a layer containing the matrix material 30, the first particles 31 and second particles 32 having a type different from that of the first particles 31, which are dispersed in the material. In the present disclosure, different types may refer to different materials, different shapes, and/or the like. For example, even in a case where the material of the first particles 31 and the material of the second particles 32 are identical to each other, the first particles 31 and the second particles 32 have different types in a case where the shapes thereof are different from each other.

The matrix material may be configured of a material selected to avoid contaminating the photoreceptor that is a charged body. The matrix material, for example, contains a base polymer. According to examples, the base polymer may be a polymer such as a fluorine resin, a polyamide resin, an acrylic resin, a nylon resin, a polyurethane resin, a silicone resin, a butyral resin, a styrene-ethylene.butylene-olefin copolymer (SEBC), and an olefin-ethylene.butylene-olefin copolymer (CEBC). A single type of the materials may be used in some examples, or two or more types thereof may be used in combination in other examples. For example, from the viewpoint of ease of handling, the size of a freedom degree of material design (e.g. flexibility of the material design), or the like, the base polymer may be at least one type selected from the group consisting of a fluorine resin, an acrylic resin, a nylon resin, a polyurethane resin, and a silicone resin according to some examples, or may be at least one type selected from the group consisting of a nylon resin and a polyurethane resin according to other examples.

The content of the base polymer in the resin layer, for example, may be 30 mass % to 90 mass %, based on the total amount of the resin layer.

The matrix material, for example, may further contain various conductive agents (conductive carbon, graphite, copper, aluminum, nickel, an iron powder, conductive tin oxide, conductive titanium oxide, an ion conductive agent, and the like), a charging control agent, and/or the like.

The particles (for example, the first particles 31 and the second particles 32) may be insulating particles. The particles may be resin particles, or may be inorganic particles. The particles are selected to form irregularities with respect to the surface of the resin layer in order to achieve a sufficient discharge surface area. Examples of the material of the resin particles include a urethane resin, a polyamide resin, a fluorine resin, a nylon resin, an acrylic resin, a urea resin, and the like. Examples of the material of the inorganic particles include silica, alumina, and the like. A single type of the materials may be used according to some examples, or two or more types thereof may be used in combination according to other examples. From the viewpoint of compatibility with respect to the matrix material 30, dispersion retainability after the particles are added, stability after being a coating material (a pot life), or the like, the particles may be at least one type selected from the group consisting of nylon resin particles, acrylic resin particles, and polyamide resin particles according to some examples, or may be at least one type selected from the group consisting of nylon resin particles and acrylic resin particles according to other examples.

The particles (for example, the first particles 31 and the second particles 32) may have a shape in which the irregularity can be formed with respect to the surface of the conductive resin layer, and may be a spherical shape and an oval spherical shape, an amorphous shape, and the like.

In a case where the particles includes the first particles 31 exclusively, an average particle diameter B of the first particles 31 (a “B” portion in FIG. 2) may be 5.0 μm to 50.0 μm, in order to suppress charging unevenness that may cause an initial image defect. In some examples, the average particle diameter B of the first particles 31 may be 15.0 μm to 30.0 μm to further suppress charging unevenness. Herein, the average particle diameter of the particles can be derived by arbitrarily extracting 100 particles from a population of a plurality of particles with SEM observation, and by obtaining an average value of particle diameters. However, in a case where a particle shape is not a spherical shape, but is a shape in which a particle diameter is not uniformly set, such as an oval spherical shape (a sectional surface is in the shape of an oval sphere) or an amorphous shape, a simple average value of the longest diameter and the shortest diameter can be set as the particle diameter of the particles.

In a case where the resin layer 3 contains the first particles 31 and the second particles 32, the average particle diameter B of the first particles 31 (a “B” portion in FIG. 3) may be 15.0 μm to 40.0 μm, in order to suppress the charging unevenness that may cause the initial image defect, and an average particle diameter C of the second particles 32 (a “C” portion in FIG. 3) may be 15.0 μm to 40.0 μm, as an average particle diameter, in order to suppress the charging unevenness that may cause the initial image defect. From the viewpoint of suppressing the charging unevenness, the average particle diameter B of the first particles 31 may be greater than the average particle diameter C of the second particles 32. For example, the average particle diameter B of the first particles 31 may be greater than the average particle diameter C of the second particles 32 by 10 μm or more.

An interparticle distance of the particles (that is, an interparticle distance of all of the particles including the first particles 31 and the second particles 32 included in accordance with a case) may be 50 μm to 400 μm. Surface roughness of the conductive resin layer and particle dropout are more easily suppressed by setting the interparticle distance to be 50 μm or more, and the particle dropout is more easily suppressed by setting the interparticle distance to be 400 μm or less. From the same viewpoint, the interparticle distance may be 75 μm to 300 μm in some examples, or may be 100 μm to 250 μm in other examples. The interparticle distance can be measured based on JIS B0601-1994.

The resin layer 3 may contain the particles described above to form an irregular surface. In the resin layer 3 containing the particles, a layer thickness A (an “A” portion in FIG. 2 and FIG. 3) of a portion not containing any of the particles (a portion not containing any of the first particles 31 nor of the second particles 32), e,g., a portion containing the matrix material 30 exclusively, for example, may be within a range having a minimum of 1.0 μm, of 2.0 μm, or of 3.0 μm, and having a maximum of 7.0 μm, 6.0 μm, or 5.0 μm. Namely, the layer thickness A is a thickness at a middle point between the nearest particles (e.g., closest adjacent particles). By setting the layer thickness A to be 1.0 μm or more, the resin particles to be added are more easily continuously retained without having any dropout of the resin particles for a long period of time. By setting the layer thickness A to be 7.0 μm or less, a suitable charging performance is more easily maintained. The layer thickness A may be measured by cutting out a sectional surface of the conductive body 5 with a sharp blade, and by observing the sectional surface with an optical microscope or an electronic microscope.

A ratio (B/A) of the average particle diameter B of the first particles 31 to the layer thickness A of the resin layer 3 may be 5.0 to 30.0. A suitable charging evenness is more easily achieved by setting B/A to be 5.0 or more, and coating properties of a coating liquid for forming a conductive resin layer are more easily improved and the particle dropout is more easily suppressed by setting B/A to be 30.0 or less. From the same viewpoint, B/A may be 7.5 to 20.0, or may be 8.0 to 12.5.

According to examples, the content of the particles (for example, the total amount of the first particles 31 and the second particles 32) may be 5 mass % to 50 mass %, based on the total mass of the resin layer. The charging performance tends to be more easily satisfied by setting the content of the particles to be 5 mass % or more, and the control of particle precipitation at the time of being a coating material is further facilitated and coating material stability tends to be prevented from degrading by setting the content of the particles to be 50 mass % or less. From the same viewpoint, the content of the particles may be 10 mass % to 40 mass % in some examples, or may be 20 mass % to 30 mass % in other examples, based on the total mass of the resin layer. The content of the particles contained in the resin layer, for example, can be quantified by sampling the resin layer from the charging member, and by measuring a weight change (TG), differential heat (DTA), calory (DSC), and the mass (MS) of a volatile component, which occur by heating the sampled resin layer (TG-DTA-MS, DSC (heat analysis)).

In a case where the particles include the first particles 31 and the second particles 32, a ratio of the content of the first particles 31 to the content of the second particles 32, for example, may be 5:1 to 1:5 in some examples, or may be 3:1 to 1:3 in other examples, in order to achieve a suitable charging performance.

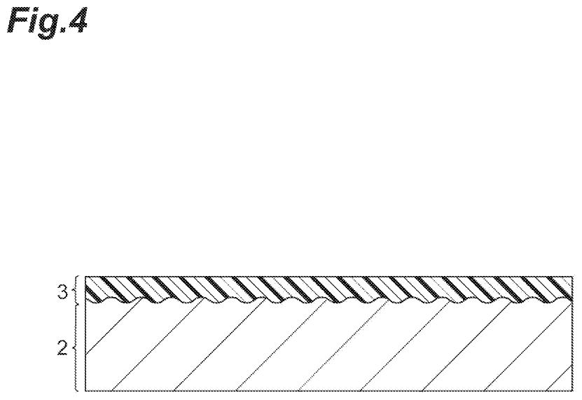

The resin layer 3, for example, as illustrated in FIG. 4, may be a layer formed by impregnating the surface of the originally existing elastic layer with a solution containing an isocyanate compound, and by subsequently curing the solution. In this case, a cured portion on the surface side of the originally existing elastic layer forms the resin layer and other cured portions form the elastic layer 2.

The isocyanate compound, for example, may be 2,6-tolylene diisocyanate (TDI), 4,4′-diphenyl methane diisocyanate (MDI), paraphenylene diisocyanate (PPDI), 1,5-naphthalene diisocyanate (NDI), and 3,3-dimethyl diphenyl-4,4′-diisocyanate (TODI), multimers and modified bodies thereof, and the like.

A solvent of the solution containing the isocyanate compound may be an organic solvent in which the isocyanate compound can be dissolved. The organic solvent, for example, may be ethyl acetate or the like. The solution may further contain carbon black, at least one type of polymer selected from the group consisting of an acrylic fluorine-based polymer and an acrylic silicone-based polymer, a conductivity imparting agent, and/or the like.

The resin layer thus formed by impregnating the elastic layer with the solution containing the isocyanate compound, and by curing the solution, for example, may contain the elastic body configuring the elastic layer 2, and a resin derived from the isocyanate compound.

The elastic body may be formed by using a base polymer containing acrylonitrile-butadiene rubber (NBR) or epichlorohydrin rubber as a main component, to achieve suitable binding properties with respect to the resin derived from the isocyanate compound. Namely, the base polymer may contain 50 mass % or more of acrylonitrile-butadiene rubber (NBR) or epichlorohydrin rubber, or in other examples, may contain 80 mass % or more of acrylonitrile-butadiene rubber (NBR) or epichlorohydrin rubber.

The resin derived from the isocyanate compound, for example, may be a resin having a urea bond, a urethane bond, or the like (a urea resin, a urethane resin, or the like). The resin derived from the isocyanate compound may be bonded to the base polymer and/or the cross-linked body in the elastic body by a urethane bond or the like,

The thickness of the resin layer 3 illustrated in FIG. 4, for example, may be within a range having a minimum of 1.0 μm, 10.0 μm, or 20.0 μm, and may have a maximum of 250.0 μm, 200.0 μm, or 150.0 μm.

Coating Layer

The coating layer 4 contains a polysiloxane compound having an Si—O—Zr bond in the molecular structure (hereinafter, also referred to as a “polysiloxane compound A”). The Si—O—Zr bond, for example, is a bond to be formed between a zirconium chelate compound and a hydrolyzable silane compound at the time of polymerizing (self-condensing) the hydrolyzable silane compound in the presence of the zirconium chelate compound. The surface of the coating layer 4 containing the polysiloxane compound A is located on the resin layer 3 to form an outermost surface S of the conductive body 5, and thus, the contamination on the surface of the conductive body 5 due to the contact with the photoreceptor (for example the contamination due to the external additive) is suppressed. Here, the “polysiloxane compound” refers to a compound having a plurality of Si—O—Si bonds (siloxane bonds) in the molecular structure. Si configuring the Si—O—Si bond can be the same as Si configuring an Si—O—Zr bond. Three or four oxygen atoms may be bonded to Si configuring the Si—O—Si bond and the Si—O—Zr bond.

The polysiloxane compound A may have a cross-linking structure derived from an epoxy group, in order to achieve a suitable surface hardness. Namely, the polysiloxane compound A may have a structural unit represented by Formula (1) or (2) described below.

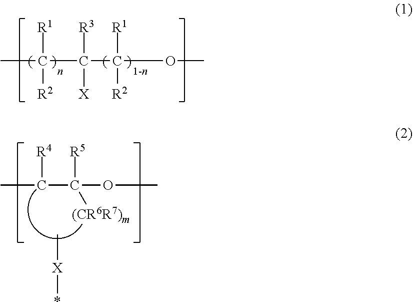

In Formula (1), R¹ to R³ each independently indicates a hydrogen atom, an alkyl group having 1 to 4 carbon atoms, a hydroxyl group, a carboxyl group, or an amino group, X indicates a single bond or a divalent organic group, * indicates a bonding hand with respect to Si, and n indicates 0 or 1. Si may be Si configuring the Si—O—Zr bond, or may be Si configuring the Si—O—Si bond.

In Formula (2), R⁴ to R⁵ each independently indicates a hydrogen atom, an alkyl group having 1 to 4 carbon atoms, a hydroxyl group, a carboxyl group, or an amino group, R⁶ to R⁷ each independently indicates a hydrogen atom, an alkyl group having 1 to 4 carbon atoms, and an alkoxyl group having 1 to 4 carbon atoms, and m indicates an integer of 4 to 12. X and * have the same meaning as X and * in Formula (1).

A divalent organic group of X, for example, may be a divalent hydrocarbon group having 1 to 16 carbon atoms. A part of the carbon atoms of the hydrocarbon group may be substituted with an oxygen atom. The hydrocarbon group may be a straight-chain hydrocarbon group, may be a branched-chain hydrocarbon group, or may be a saturated or unsaturated hydrocarbon group. Namely, the divalent organic group may be a group represented by Formula (3) or Formula (4) described below.

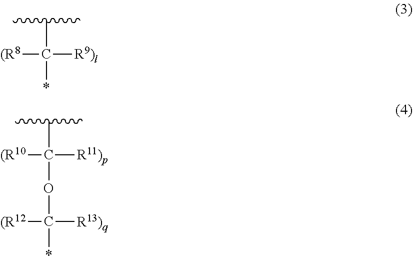

In Formula (3), R⁸ to R⁹ each independently indicates a hydrogen atom or an alkyl group having 1 to 4 carbon atoms, and I indicates an integer of 1 to 8. In Formula (4), R¹° to R¹³ each independently indicates a hydrogen atom or an alkyl group having 1 to 4 carbon atoms, and p and q each independently indicates an integer of 1 to 8. * in Formula (3) and Formula (4) has the same meaning as * in Formula (1) or Formula (2).

The structural unit represented by Formula (1) described above may be a structural unit represented by Formula (5) or Formula (6) described below.

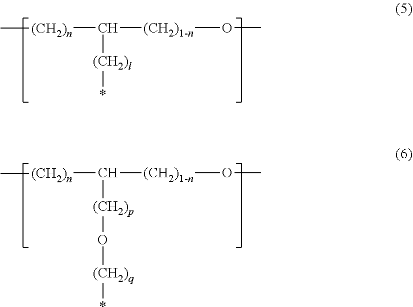

In Formula (5) and Formula (6), n and * are the same as n and * in Formula (1). I in Formula (5) is the same as I in Formula (3), and p and q in Formula (6) are the same as p and q in Formula (4).

The structural unit represented by Formula (2) described above may be a structural unit represented by Formula (7) or (8) described below.

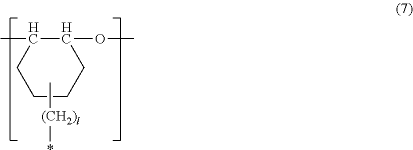

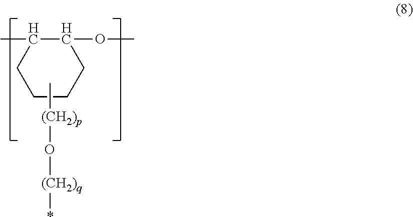

* in Formula (7) and Formula (8) has the same meaning as * in Formula (2). I in Formula (7) is the same as I in Formula (3), and p and q in Formula (8) have the same meaning as p and q in Formula (4).

The polysiloxane compound A may have a perfluoroalkyl group, in order to further decrease surface free energy of the surface of the conductive body 5 (the surface of the coating layer 4), and to further suppress the contamination on the surface of the conductive body 5 due to the contact with the photoreceptor (for example, the contamination due to the external additive). The number of carbon atoms of the perfluoroalkyl group may be 1 or more in some example, may be 3 or more in other examples, or may be 5 or more in yet other examples. The number of carbon atoms of the perfluoroalkyl group may be 18 or less in some examples, may be 12 or less in other examples, or may be 10 or less in yet other examples. The perfluoroalkyl group may be a straight-chain perfluoroalkyl group in some examples, may be a branched-chain perfluoroalkyl group in other examples, or may be a saturated or unsaturated perfluoroalkyl group in yet other examples.

The perfluoroalkyl group may be bonded to Si directly or via the divalent organic group. The details of the divalent organic group described above are the same as the details of the divalent organic group of X in Formula (1), Si may be Si configuring the Si—O—Zr bond, or may be Si configuring the Si—O—Si bond.

The polysiloxane compound A may have a structure represented by Formula (9) described below, in order to further decrease a frictional coefficient of the surface of the conductive body 5 (the surface of the coating layer 4), and to further suppress the contamination on the surface of the conductive body 5 due to the contact with the photoreceptor (for example, the contamination due to the external additive).

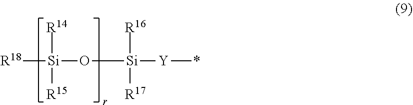

In Formula (9), R¹⁴ to R¹⁸ each independently indicates an alkyl group having 1 to 4 carbon atoms, r indicates an integer of 10 to 100, and Y indicates a divalent organic group. * in Formula (9) has the same meaning as * in Formula (1).

Y in Formula (9) may have an oxazolidone ring in a main chain. Namely, Y may be a group represented by Formula (10) or (11) described below.

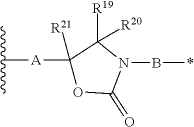

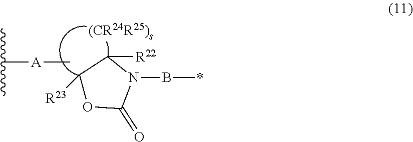

In Formula (10), R¹⁹ to R²¹ each independently indicates a hydrogen atom, an alkyl group having 1 to 4 carbon atoms, a hydroxyl group, a carboxyl group, or an amino group. In Formula (11), R²² to R²³ each independently indicates a hydrogen atom, an alkyl group having 1 to 4 carbon atoms, a hydroxyl group, a carboxyl group, or an amino group, R²⁴ to R²⁵ each independently indicates a hydrogen atom, an alkyl group having 1 to 4 carbon atoms, or an alkoxyl group having 1 to 4 carbon atoms, and s indicates an integer of 4 to 12. In Formula (10) and Formula (11), A and B each independently indicates a single bond or a divalent organic group. The details of the divalent organic group are the same as the details of the divalent organic group of X in Formula (1) described above. * in Formula (10) and Formula (11) has the same meaning as * in Formula (9).

Surface free energy γ^{Total} of the coating layer 4 (surface free energy of the outermost surface of the conductive body 5) may be 35.0 mJ/m² or less in some examples, may be 25.0 mJ/m² or less in other examples, or may be 20,0 mJ/m² or less in yet other examples, from the viewpoint of further suppressing the contamination on the surface of the conductive body 5 due to the contact with the photoreceptor (for example, the contamination due to the external additive). The surface free energy γ^{Total} of the coating layer 4 is measured by a method described in Test Examples described below.

The surface free energy described above is a sum of a dispersion component (γs^{d}), a dipole component (γs^{p}), and a hydrogen-bond component (γs^{h}). In addition to the above-range of the surface free energy of the coating layer 4, a sum of the dipole component (γs^{p}) and the hydrogen-bond component (γs^{h}) may be 12.0 mJ/m² or less in some examples, may be 8.0 mJ/m² or less in other examples, or may be 5.0 mJ/m² or less in yet other examples, in order to further suppress the contamination on the surface of the conductive body 5 due to the contact with the photoreceptor (for example, the contamination due to the external additive).

A surface frictional force of the coating layer 4 may be 0.040 N or less in some examples, may be 0.035 N or less in other examples, or may be 0.030 N or less in yet other examples, in order to further suppress the contamination on the surface of the conductive body 5 due to the contact with the photoreceptor (for example, the contamination due to the external additive). The surface frictional force described above is measured by using a surface property meter (TYPE: 38, manufactured by Shinto Scientific Co., Ltd.), and under the measurement conditions including: a continuous load type (having a maximum load of 25 g), a diamond-tip terminal R0.1, a measured length of 50.0 mm, and a data acquisition frequency of 100 Hz.

The thickness of the coating layer 4, for example, may be within a range having a minimum of 30 nm, 50 nm, or 70 nm, and a maximum of 500 nm, 400 nm, or 300 nm.

The charging roller 10 may have irregularities on the surface. Ten-point average roughness Rzjis of the surface of the charging roller 10 may be within a range having a minimum of 15.0 μm, 18.0 μm, 20.0 μm, 22.0 μm, 22.5 μm, or 23.0 μm, in order to suppress the charging unevenness, and having a maximum of 30.0 μm, 29.0 μm, 28.0 μm, 27.5 μm, 27.0 μm, 26.5 μm, or 26.0 μm, in order to suppress rotation unevenness of the charging roller 10 (a circumferential speed deviation).

The ten-point average roughness Rzjis of the surface of the charging roller 10 is measured based on JIS B0601-2001 by using a surface roughness meter SE-3400 manufactured by Kosaka Laboratory Ltd. The ten-point average roughness Rzjis (and other surface properties of the charging roller 10) can be adjusted by changing the size, the shape, the amount, or the like of the particles contained in the resin layer 3.

The conductive body 5 may include a surface that is curved with respect to the rotation axis line L. That is, the surface of the coating layer 4 may be curved with respect to the rotation axis line L. The shortest distance (corresponding to ½ of an outer diameter of the conductive body 5) from the rotation axis line L to the surface of the conductive body 5 (the surface of the coating layer 4) varies along the rotation axis line L. Namely, the shortest distance from the rotation axis line L to the surface of the conductive body 5 reaches a maximum at a center point of the conductive body 5 along the rotation axis line L (a center point of the conductive body 5 in a longitudinal direction), and decreases toward the opposite end portions of the conductive body 5.

A crown amount can be used as an index expressing a roller shape of the conductive body 5. The crown amount of the conductive body 5 is defined as follows.

Crown Amount=D2−(D1+D3)/2

In the expression, D1 indicates the outer diameter of the conductive body 5 at a position that is separated from one end of the conductive body 5 by 30 mm in the longitudinal direction (a rubber length) toward the center point, D2 indicates the outer diameter of the conductive body 5 at the center point of the conductive body 5 in the longitudinal direction (the rubber length), and D3 indicates the outer diameter of the conductive body 5 at a position that is separated from the other end of the conductive body 5 by 30 mm in the longitudinal direction (the rubber length) toward the center point.

The crown amount of the conductive body 5 may be within a range having a minimum of 50 μm, 60 μm, or 70 μm, and may have a maximum of 130 μm, 120 μm, or 110 μm, in order to achieve a stable charging evenness for a relatively long period of time while allowing the charging roller 10 to suitably contact (or cohere to) the photoreceptor, and to maintain the granularity of the image quality.

The charging member described above may be provided in an image forming apparatus, in order to charge the photoreceptor. Namely, the charging member may perform a uniform charging treatment to the surface of the photoreceptor that is an image carrier. Namely, an example of the image forming apparatus includes the photoreceptor, and the charging member to charge the photoreceptor.

In the image forming apparatus, for example, a direct-current voltage exclusively, may be applied to the charging member. At this time, a bias voltage to be applied while an image is output may be −1000 V to −1500 V.

Manufacturing Method of Charging Member

Hereinafter, an example manufacturing method of the example charging member 10 will be described.

The manufacturing method of the charging roller 10 includes preparing the conductive base 6 that is mountable on the conductive support 1, preparing a coating liquid containing a composition containing a hydrolyzable silane compound and a zirconium chelate compound, applying the coating liquid onto the surface of the conductive base 6, and curing the composition to form the coating layer 4 over the conductive base 6.

The conductive base 6, for example, can be prepared as follows. First, a material for an elastic layer and a coating liquid for a resin layer are prepared. The material for an elastic layer can be prepared by kneading a material for the elastic layer 2 with a kneading machine such as a kneader. In addition, the coating liquid for a resin layer can be prepared by kneading a material for the resin layer 3 with a kneading machine such as a roll, by adding an organic solvent to the mixture, and by performing mixing and stirring. Next, a metal mold for injection molding, in which a core bar that is the conductive support 1 is set, is filled with the material for an elastic layer, and is thermally crosslinked under a predetermined condition. After that, demolding is performed, and thus, a base roll is manufactured in which the elastic layer is formed along the outer circumferential surface of the conductive support 1. Next, the coating liquid for a resin layer is applied onto an outer circumferential surface of the base roll described above, so as to form the resin layer 3. At this time, in a case where of a solution containing an isocyanate compound is used, the elastic layer of the base roll is impregnated with the solution, and then, the solution is cured, so as to form the resin layer 3. Namely, a cured portion on the surface side elastic layer of the base roll forms the resin layer 3, and an uncured portion forms the elastic layer 2. As described above, it is possible to prepare the conductive base 6 including the elastic layer 2 formed on the outer circumferential surface of the conductive support 1, and the resin layer 3 formed on the outer circumferential surface of the elastic layer 2.

The formation method of the elastic layer is not limited to an injection molding method, and in other examples, a cast molding method, or a method in which press molding and grinding are combined, may be adopted. In addition, the coating method of the coating liquid for a resin layer is not particularly limited, and in other examples, a dipping method, a roll coating method, and the like may be adopted.

The coating liquid, for example, may contain a composition containing a hydrolyzable silane compound and a zirconium chelate compound (a curable composition) that is a curable component, and a solvent in which the components of the composition are dissolved or dispersed. Here, the curable component indicates a component to be incorporated in the structure of a polysiloxane compound that is generated at the time of curing the coating liquid. For this reason, an acid generating agent described below is not contained in the curable component.

The hydrolyzable silane compound has a hydrolyzable silyl group represented by Formula (12) described below.

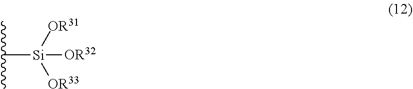

In Formula (12), R³¹ to R³³ each independently indicates a hydrocarbon group. The hydrocarbon group, for example, is an alkyl group having 1 to 4 carbon atoms. One type of the hydrolyzable silane compound may be independently used in some examples, or a plurality of types of the hydrolyzable silane compounds may be used in combination in other examples.

The content of the hydrolyzable silane compound may be 84.0 mol % or more, may be 88.0 mol % or more, or may be 90.0 mol % or more, with respect to the total amount of the curable component, in order to achieve a suitable condensation efficiency. The content of the hydrolyzable silane compound may be 98.0 mol % or less, may be 97.0 mol % or less, or may be 96.0 mol % or less, with respect to the total amount of the curable component, in order to achieve a suitable condensation efficiency.

The zirconium chelate compound has a zirconium atom (Zr) that is a central metal, and 1 to 4 chelate ligands (polydendate ligands) that are coordinated to the zirconium atom. The zirconium chelate compound accelerates a polymerization (self-condensation) reaction of the hydrolyzable silane compound, and contributes to the formation of a coating layer having low surface free energy.

The chelate ligand, for example, may be a bidentate ligand or a tridentate ligand. A ligand atom of the chelate ligand may be an oxygen atom, for example. Namely, the chelate ligand may be an acetylacetonate group or an alkyl acetoacetate group. The alkyl of the alkyl acetoacetate group, for example, may be an alkyl having 1 to 10 carbon atoms.

The zirconium chelate compound has a monodentate ligand. The monodentate ligand, for example, may be an alkoxy group. The number of carbon atoms of the alkoxy group, for example, may be 1 to 10.

The zirconium chelate compound, for example, may be zirconium tributoxymonoacetylacetonate, zirconium dibutoxybis(acetylacetonate), zirconium dibutoxybis(ethyl acetoacetate), or the like. One type of zirconium chelate compound may be independently used in some examples, or a plurality of types of the zirconium chelate compounds may be used in combination in other examples.

The content of the zirconium chelate compound may be 2,0 mol % or more, may be 3.9 mol % or more, or may be 4.0 mol % or more, with respect to the total amount of the curable component, to reduce a reaction time.

The content of the zirconium chelate compound may be 10.0 mol % or less, may be 8.0 mol % or less, or may be 6.0 mol % or less, with respect to the total amount of the curable component, to achieve a suitable condensation rate.

The composition may contain a hydrolyzable silane compound having an epoxy group, as the curable component. That is, at least a part of the hydrolyzable silane compound may be the hydrolyzable silane compound having an epoxy group. According to the hydrolyzable silane compound having an epoxy group, it is possible to use photocationic polymerization and thermal curing in combination. The hydrolyzable silane compound having an epoxy group, for example, may have a structure represented by Formula (13) or (14) described below, to suppress the occurrence of polymerization inhibition due to oxygen and to achieve more suitable surface curing properties.

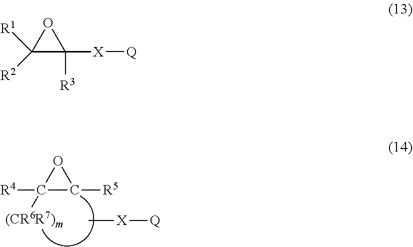

In Formula (13), R¹ to R³ and X have the same meaning as R¹ to R³ and X in Formula (1). In Formula (14), R⁴ to R⁷, and m and X have the same meaning as R⁴ to R⁷, and m and X in Formula (2). Q in Formula (13) and Formula (14) indicates the hydrolyzable silyl group represented by Formula (12) described above.

The hydrolyzable silane compound having an epoxy group, for example, may be (3-glycidoxypropyl) trimethoxysilane, (3-glycidoxypropyl) triethoxysilane, 2-(3,4-epoxy cyclohexyl) ethyl trimethoxysilane, 2-(3,4-epoxy cyclohexyl) ethyl triethoxysilane, or the like. One type of the hydrolyzable silane compound having an epoxy group may be independently used in some examples, or a plurality of types of the hydrolyzable silane compounds having an epoxy group may be used in combination in other examples.

The content of the hydrolyzable silane compound having an epoxy group may be 80.0 mol % or more, may be 85.0 mol % or more, or may be 90.0 mol % or more, with respect to the total amount of the curable component, to further suppress the polymerization inhibition due to the oxygen and to achieve further suitable surface curing properties. The content of the hydrolyzable silane compound having an epoxy group may be 97,5 mol % or less, may be 96.0 mol % or less, or may be 95.0 mol % or less, with respect to the total amount of the curable component, to reduce cure shrinkage and to achieve a suitable adhesiveness (or cohesiveness) with a surface layer resin.

The composition containing the hydrolyzable silane compound having an epoxy group may further contain an acid generating agent. The acid generating agent may be a photo-acid generating agent, or may be a thermal-acid generating agent. One type of the acid generating agent may be independently used according to some examples, or a plurality of types of the acid generating agents may be used in combination according to other examples.

The photo-acid generating agent may be a photo-acid generating agent that is capable of performing activation with light having a wavelength of 365 nm to 405 nm from a UV-LED light source, in order to suppress a damage on the base material due to heat from a light source and oxidation degradation of the coating layer. The photo-acid generating agent, for example, may be a triarylsulfonium salt-based photo-acid generating agent or the like.

The thermal-acid generating agent may be a thermal-acid generating agent that is capable of performing activation at a low temperature (for example, 250° C. or less), in order to suppressing the damage on the base material due to heat and the oxidation degradation of the coating layer. The thermal-acid generating agent, for example, may be a quaternary ammonium trifluoromethane sulfonic acid or the like.

The content of the acid generating agent may be 0.01 parts by mass or more, may be 0.03 parts by mass or more, or may be 0.05 parts by mass or more, with respect to 100 parts by mass of a compound having an epoxy group (for example, the hydrolyzable silane compound having an epoxy group), in order to improve the condensation rate. The content of the acid generating agent may be 1.00 parts by mass or less, may be 0.08 parts by mass or less, or may be 0.07 parts by mass or less, with respect to 100 parts by mass of the compound having an epoxy group (for example, the hydrolyzable silane compound having an epoxy group), to reduce a synthesis time.

The composition may contain a hydrolyzable silane compound having a perfluoroalkyl group, as the curable component, in order to further decrease the surface free energy of the surface of the coating layer 4. For example, at least a part of the hydrolyzable silane compound may be the hydrolyzable silane compound having a perfluoroalkyl group. The hydrolyzable silane compound having a perfluoroalkyl group, for example, may have a structure represented by Formula (15) described below.

F₃C—(CF₂)ₜ—Z—Q (15)

In Formula (15), Z indicates a single bond or a divalent organic group, and t indicates an integer of 0 to 17. A hydrocarbon group, for example, may be an alkyl group having 1 to 4 carbon atoms. The value t may be within a range having a minimum of 2, or 4, and having a maximum of 11, or 9. The details of the divalent organic group are the same as the details of the divalent organic group of X in Formula (1) described above. Q indicates the hydrolyzable silyl group represented by Formula (12) described above.

The hydrolyzable silane compound having a perfluoroalkyl group, for example, may be (heptadecafluoro-1,1,2,2-tetrahydrodecyl) trimethoxysilane, (heptadecafluoro-1,1,2,2-tetrahydrodecyl) triethoxysilane, (tridecafluoro-1,1,2,2-tetrahydrooctyl) trimethoxysilane, (tridecafluoro-1,1,2,2-tetrahydrooctyl) triethoxysilane, or the like. One type of the hydrolyzable silane compound having a perfluoroalkyl group may be independently used in some examples, or a plurality of types of the hydrolyzable silane compounds having a perfluoroalkyl group may be used in combination in other examples.

The content of the hydrolyzable silane compound having a perfluoroalkyl group may be 1.0 mol % or more, may be 2.0 mol % or more, or may be 3.0 mol % or more, with respect to the total amount of the curable component, from the viewpoint of further decreasing the surface free energy. The content of the hydrolyzable silane compound having a perfluoroalkyl group may be 10.0 mol % or less, may be 9.0 mol % or less, or may be 8.0 mol % or less, with respect to the total amount of the curable component, in order to achieve suitable orientation properties (flip properties) of the perfluoroalkyl group.

The composition may contain a one end-modified silicone compound having a structure represented by Formula (16) described below (a silicone compound having a reactive group on one terminal), and a hydrolyzable silane compound having a functional group capable of forming a bond by reacting with a reactive group of the silicone compound (hereinafter, also referred to as a “bonding functional group”), as the curable component, in order to reduce the frictional coefficient of the surface of the coating layer 4.

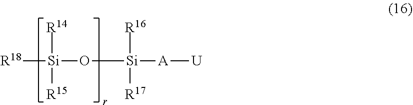

In Formula (16), U indicates a reactive group. R¹⁴ to R¹⁸ and r have the same meaning as R¹⁴ to R¹⁸ and r in Formula (9), and A has the same meaning as A in Formulas (10) and (11).

The one end-modified silicone compound reacts with the hydrolyzable silane compound having a bonding functional group, so as to generate a silicone compound having excellent compatibility with respect to other components in the coating liquid (for example, hydrolyzable silane having an epoxy group). Accordingly, it is possible to suppress the occurrence of phase separation in the coating layer 4, and to reduce the frictional coefficient over the entire surface of the coating layer 4.

The reactive group, for example, may be an epoxy group. Namely, the reactive group may be a group represented by Formula (17) or (18) described below.

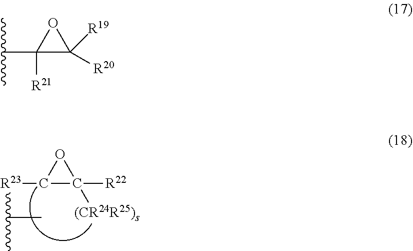

In Formula (17), R¹⁹ to R²¹ have the same meaning as R¹⁹ to R²¹ in Formula (10). In Formula (18), R²² to R²⁵ and s have the same meaning as R²² to R²⁵ and sin Formula (11).

A functional group equivalent (a reactive group equivalent) of the one end-modified silicone compound, for example, may be 1000 g/mol to 5000 g/mol.

The viscosity of the one end-modified silicone compound at 25° C. may be 10 mm²/s to 120 mm²/s, for example.

One type of the one end-modified silicone compound may be independently used in some examples, or a plurality of types of the one end-modified silicone compounds may be used in combination in other examples.

The content of the one end-modified silicone compound may be 0.1 mol % or more, may be 0.2 mol % or more, or may be 0.3 mol % or more, with respect to the total amount of the curable component, in order to further reduce the frictional coefficient. The content of the one end-modified silicone compound may be 1,0 mol % or less, may be 0.9 mol % or less, or may be 0.8 mol % or less, with respect to the total amount of the curable component, in order to suppress the phase separation.

The hydrolyzable silane compound having a bonding functional group, for example, may have a structure represented by Formula (19) described below.

L—B—Q (19)

In Formula (19), L indicates a bonding functional group, and Q indicates a hydrolyzable silyl group represented by Formula (12) described above. B has the same meaning as B in Formulas (10) and (11).

The bonding functional group indicated by L, for example, may be a functional group capable of forming a bond by reacting with an epoxy group (an amino group, an isocyanate group, or the like), or may be an isocyanate group, in order to further reduce the frictional coefficient of the surface of the coating layer 4.

The hydrolyzable silane compound having a bonding functional group, for example, may be 3-isocyanate propyl trimethoxysilane, 3-isocyanate propyl triethoxysilane, or the like. One type of the hydrolyzable silane compound having a bonding functional group may be independently used in some examples, or a plurality of types of the hydrolyzable silane compounds having a bonding functional group may be used in combination in other examples.

The content of the hydrolyzable silane compound having a bonding functional group may be 1.0 mol % or more, may be 1.5 mol % or more, or may be 2.0 mol % or more, with respect to the total amount of the curable component, from the viewpoint of suppressing the phase separation. The content of the hydrolyzable silane compound having a bonding functional group may be 5.0 mol % or less, may be 4.5 mol % or less, or may be 4.0 mol % or less, with respect to the total amount of the curable component, from the viewpoint of further reducing the frictional coefficient.

The composition may further contain a reaction product between the one end-modified silicone compound and the hydrolyzable silane compound having a bonding functional group. The reaction product may be synthesized in advance before the coating liquid is prepared, or may be generated in the coating liquid. In a case where the composition contains the reaction product, the content of the one end-modified silicone compound and the hydrolyzable silane compound having a bonding functional group is calculated by considering that the one end-modified silicone compound and the hydrolyzable silane compound having a bonding functional group are respectively compounded.

The composition may contain the hydrolyzable silane compound having an epoxy group, the hydrolyzable silane compound having a perfluoroalkyl group, the zirconium chelate compound, and the acid generating agent, in order to enable the coating layer 4 in which surface free energy of 35.0 mJ/m² or less and a sum of a dipole component and a hydrogen-bond component of the surface free energy is 12.0 mJ/m² or less to be easily formed.

The composition may contain the hydrolyzable silane compound having an epoxy group, the one end-modified silicone compound having an epoxy group as the reactive group, the hydrolyzable silane compound having an isocyanate group as the bonding functional group, the zirconium chelate compound, and the acid generating agent, in order to enable the coating layer 4 having a surface frictional force of 0.040 N or less to be easily formed.

The solvent, for example, may contain water. The solvent may further contain an alcohol solvent. That is, the solvent may be a mixed solvent of water and the alcohol solvent. In this case, the content of water in the solvent may be 10.0 mass % or more, and may be 60.0 mass % or less, based on the total mass of the solvent. Methanol, ethanol, isopropyl alcohol, or the like, may be used as the alcohol solvent.

The content of the solvent, for example, may be adjusted to achieve a suitable viscosity of the coating liquid. The content of the solvent, for example, may be 95.0 mass % to 99.9 mass %, based on the total mass of the coating liquid.

A coating method of the coating liquid may include a dipping method, a spray coating method, a roll coating method, and the like, depending on examples.

Drying or the like may be performed after the coating liquid is applied and before the composition is cured so that the solvent in the formed coating may be removed. The drying may be performed at 130° C. to 220° C.

A curing method of the composition is not particularly limited. In a case where the composition contains the acid generating agent, suitable curing methods (e.g., heating, light irradiation, or the like) may be adopted, in accordance with the type of acid generating agent. The heating and the light irradiation may be used in combination as the curing method. In a case of using the photo-acid generating agent, the composition may be cured by being irradiated with light having a wavelength of 365 nm to 405 nm from the UV-LED light source, in order to suppress the damage on the base due to heat generated from the light source and the oxidation degradation of the coating layer. The UV-LED light source, for example, may be a UV-LED light source manufactured by Hamamatsu Photonics K.K., a UV-LED light source manufactured by HOYA Corporation, a UV-LED light source manufactured by Iwasaki Electric Co., Ltd., a UV-LED light source manufactured by Ushio Inc., a UV-LED light source manufactured by Heraeus K.K., a UV-LED light source manufactured by AITEC SYSTEM Co., Ltd., a UV-LED light source manufactured by Micro-Sphere S.A., and the like. In addition, in a case of using the acid generating agent, the composition may be cured by being heated at 250° C. or less, in order to suppress the damage on the base due to heat and the oxidation degradation of the coating layer.

### Test Examples

Hereinafter, Test Examples relating to the charging member will be described.

Manufacturing of Conductive Base A

Preparation of Material for Forming Elastic Layer

100.00 parts by mass of epichlorohydrin rubber (“EPICHLOMER CG-102” manufactured by DAISO CHEMICAL CO. LTD.) as a rubber component, 5.00 parts by mass of sorbitan fatty acid ester (“SPLENDER R-300”, manufactured by Kao Corporation) as a lubricant, 5.00 parts by mass of a ricinoleic acid as a softener, 0.50 part by mass of a hydrotalcites compound (“DHT-4A”, manufactured by Kyowa Chemical Industry Co., Ltd.) as an add acceptor, 1.00 part by mass of tetrabutyl ammonium chloride (“tetrabutyl ammonium chloride”, manufactured by Tokyo Chemical Industry Co., Ltd.) as a conductive agent (an ion conductive agent), 50.00 parts by mass of silica (“Nipsil ER”, manufactured by Tosoh Silica Corporation) as a filler, 5.00 parts by mass of zinc oxide as a cross-linking promoter, 1.50 parts by mass of dibenzothiazole sulfide, 0.50 part by mass of tetramethyl thiuram monosulfide, and 1.05 parts by mass of sulfur as a cross-linking agent were compounded, and were kneaded by using a predetermined roll, and thus, a material for forming an elastic layer was prepared.

Preparation of Coating Liquid for Forming Resin Layer

In tetrahydrofuran (THF), 100.00 parts by mass of thermoplastic N-methoxy methylated 6-nylon (“Toresin F-30K”, manufactured by Nagase ChemteX Corporation) as a polymer component, 5.00 parts by mass of methylene bisethyl methyl aniline (“CUREHARD-MED”, manufactured by Ihara Chemical Industry Co., Ltd.) as a curing agent, and 18.00 parts by mass of carbon black (“Denka Black HS100”, manufactured by Denka Company Limited) as a conductive agent (an electroconductive agent) were mixed. In such a mixed liquid, two types of amorphous nylon resin particles having different average particle diameters (25.0 μm and 5.0 μm) (“Orgasol Series”, manufactured by Arkema S.A.) were added as the first particles 31 and the second particles 32, and were sufficiently stirred until the solution became uniform. An additive amount was adjusted based on the total amount of the resin layer 3 to be obtained such that the content of the first particles 31 was 25 mass % and the content of the second particles 32 was 5 mass %. After that, each component in the solution was dispersed by using a double roll. Accordingly, a coating liquid for forming a resin layer was prepared.

The average particle diameter of the first particles 31 and the second particles 32 was measured as follows. That is, arbitrary 100 particles were extracted from a population of a plurality of particles with SEM observation, and an average value of particle diameters was set to the average particle diameter of the resin particles. A particle shape of the used resin particles was an amorphous shape, and thus, a simple average value of the longest diameter and the shortest diameter of the observed particles was set to the particle diameter of the respective particles.

Preparation of Conductive Base A

A roll molding metal mold including a cylindrical roll molding space was prepared, and a core bar having a diameter of 8 mm (the conductive support 1) was set to be coaxial with the roll molding space. The material for forming an elastic layer prepared as described above was injected into the roll molding space in which the core bar was set, was heated at 170° C. for 30 minutes, and then, was cooled, and was demolded. Accordingly, a base roll including the conductive support 1 as a conductive axis body, and the elastic layer 2 having a thickness of 2 mm (a thickness in the central position in the rotation axis line L direction) that was formed along the outer circumferential surface of the conductive support 1 was obtained.

Next, the coating liquid for forming a resin layer prepared as described above, was applied onto the surface of the elastic layer 2 of the base roll by a roll coating method. At this time, the coating was performed while an excess coating liquid was scraped with a scraper to have a targeted film thickness. After a coated film was formed, the film was heated at 150° C. for 30 minutes, so as to form the resin layer 3 having a layer thickness A of 5.0 μm. Accordingly, a conductive base A including elastic layer 2 formed along the outer circumferential surface of the axis body (the conductive support 1), and the resin layer 3 formed along the outer circumferential surface of the elastic layer 2 was prepared.

Manufacturing of Conductive Base B

As with the manufacturing of the conductive base A, a base roll including the conductive support 1 as a conductive axis body, and an elastic layer having a thickness of 3 mm (a thickness in the central position in the rotation axis line L direction) that was formed along the outer circumferential surface of the conductive support 1 was obtained. Next, 20 parts by mass of an isocyanate compound (MDI: manufactured by DIC Corporation) was added to 100 parts by mass of ethyl acetate, and was mixed and dissolved, in order to obtain an isocyanate solution. Next, the isocyanate solution was applied onto the surface of the elastic layer of the base roll, then, a portion impregnated with the isocyanate solution was cured, to form the resin layer 3 having a thickness of 50 μm. Specifically, the base roll was immersed in the isocyanate solution for 30 seconds while the temperature of the isocyanate solution was retained at 23° C., and then, the base roll was taken out, and the base roll that was taken out (the base roll of which the surface was impregnated with the isocyanate solution) was heated for 1 hour in an oven that was retained at 120° C., to form the resin layer 3. Accordingly, a conductive base B including the elastic layer 2 formed along the outer circumferential surface the axis body (the conductive support 1), and the resin layer 3 formed along the outer circumferential surface of the elastic layer 2 was prepared.

### Examples 1-1 to 1-17 and Comparative Examples (Comp. Examples) 1-1 to 1-2

Preparation of Coating Liquid

A hydrolyzable silane compound containing epoxy (hydrolyzable silane E), a hydrolyzable silane compound having a perfluoroalkyl group (hydrolyzable silane F), a zirconium chelate compound in accordance with a case, and a solvent (water and ethanol), shown in Table 1, were mixed, and then, were stirred at a room temperature, and then, were heated to reflux for 24 hours, in order to obtain a condensate of hydrolyzable silane. The condensate was added to a mixed solvent of 2-butanol/ethanol, and thus, a condensate-containing alcohol solution having a solid content shown in Table 1 was prepared. At this time, curable components (the hydrolyzable silane E, the hydrolyzable silane F, and the zirconium chelate compound) were compounded at a compounding ratio shown in Table 1 such that the total amount was 100 mol %. In addition, a compounding amount of water was adjusted such that ROR had a value shown in Table 1. Here, R_{OR} indicates a molar number ratio of water with respect to a condensation point of the silane compound to be used. For example, the minimum number of water molecules for condensing one molecule of the silane compound having a trimethoxy group is 3. Such a relationship is set to R_{OR}=1.9. An optimal range of R_{OR} is set to 1.0<R_{OR}≤2.0.

Next, an acid generating agent was dissolved in methanol, acetone, or the like, and was adjusted to be 10 mass %, and 0.35 g of the acid generating agent of 10 mass %, shown in Table 1, was added to 100 g of the condensate-containing alcohol solution, and thus, a coating liquid was prepared. The details of the compound shown in Table 1 are as follows.

KBM-403: Product Name (manufactured by Shin-Etsu Chemical Co., Ltd.), (3-Glycidoxypropyl) Trimethoxysilane

KBM-303: Product Name (manufactured by Shin-Etsu Chemical Co., Ltd.), 2-(3,4-Epoxy Cyclohexyl) Ethyl Trimethoxysilane

SIT8176.0: Product Name (Manufactured by Gelest, Inc.), (Heptadecafluoro-1,1,2,2-Tetrahydrodecyl) Trimethoxysilane

SIH5841.5: Product Name (Manufactured by Gelest, Inc.), (Tridecafluoro-1,1,2,2-Tetrahydrooctyl) Trimethoxysilane

AKZ947: Product Name (Manufactured by Gelest,Inc.), Solution of Zirconium Dibutoxybis(Acetylacetonate) (Solid Content of 25 mass %)

ZC-580: Product Name (manufactured by Matsumoto Fine Chemical Co. Ltd.), Solution of Zirconium Dibutoxybis(Ethyl Acetoacetate) (Solid Content of 70 mass %)

ZC-540: Product Name (manufactured by Matsumoto Fine Chemical Co. Ltd.), Solution of Zirconium Tributoxymonoacetylacetonate (Solid Content of 70 mass %)

CPI-410S: Product Name (manufactured by San-Apro Ltd.), Triarylsulfonium Salt-Based Photo-Acid Generating Agent

CPI-3105: Product Name (manufactured by San-Apro Ltd.), Triarylsulfonium Salt-Based Photo-Acid Generating Agent

CXC-2689: Product Name (manufactured by Kusumoto Chemicals, Ltd.), Quaternary Ammonium Salt-Based Thermal-Acid Generating Agent

CXC-1614: Product Name (manufactured by Kusumoto Chemicals, Ltd.), Quaternary Ammonium Salt-Based Thermal-Acid Generating Agent

TABLE 1

| | Conduc- | Hydrolyzable silane E | | Hydrolyzable silane F | | Zr chelate compound | | | | | | Solid |
|---|---|---|---|---|---|---|---|---|---|---|---|---|
| | tive | KBM-403 | KBM-303 | SIT8176.0 | SIH5841.5 | AKZ947 | ZC-580 | ZC-540 | | Acid generating agent | | content |
| | base | [mol %] | [mol %] | [mol %] | [mol %] | [mol %] | [mol %] | [mol %] | R_{OR} | Light | Heat | [mass %] |
| Example | A | 84.0 | | 10.0 | | 6.0 | | | 1.5 | CPI-410S | | 0.5 |
| 1-1 | | | | | | | | | | | | |
| Example | A | 84.0 | | 10.0 | | 6.0 | | | 1.5 | CPI-410S | | 1.0 |
| 1-2 | | | | | | | | | | | | |
| Example | A | 84.0 | | 10.0 | | 6.0 | | | 1.5 | CPI-410S | | 3.0 |
| 1-3 | | | | | | | | | | | | |
| Example | B | 84.0 | | 10.0 | | 6.0 | | | 1.5 | CPI-410S | | 5.0 |
| 1-4 | | | | | | | | | | | | |
| Example | A | 87.7 | | 7.5 | | 4.8 | | | 1.2 | CPI-310S | | 0.5 |
| 1-5 | | | | | | | | | | | | |
| Example | A | 87.7 | | 7.5 | | 4.8 | | | 1.2 | CPI-310S | | 1.0 |
| 1-6 | | | | | | | | | | | | |
| Example | A | 87.7 | | 7.5 | | 4.8 | | | 1.2 | CPI-310S | | 3.0 |
| 1-7 | | | | | | | | | | | | |
| Example | B | 87.7 | | 7.5 | | 4.8 | | | 1.2 | CPI-310S | | 5.0 |
| 1-8 | | | | | | | | | | | | |
| Example | A | 90.2 | | 5.0 | | 4.8 | | | 1.2 | | CXC-2689 | 0.5 |
| 1-9 | | | | | | | | | | | | |
| Example | A | 90.2 | | 5.0 | | 4.8 | | | 1.2 | | CXC-2689 | 1.0 |
| 1-10 | | | | | | | | | | | | |
| Example | B | 90.2 | | 5.0 | | 4.8 | | | 1.2 | | CXC-2689 | 3.0 |
| 1-11 | | | | | | | | | | | | |
| Example | A | 90.2 | | 5.0 | | | 4.8 | | 1.2 | | CXC-2689 | 0.5 |
| 1-12 | | | | | | | | | | | | |
| Example | A | 90.2 | | 5.0 | | | 4.8 | | 1.2 | | CXC-2689 | 1.0 |
| 1-13 | | | | | | | | | | | | |
| Example | B | 90.2 | | 5.0 | | | 4.8 | | 1.2 | | CXC-2689 | 3.0 |
| 1-14 | | | | | | | | | | | | |
| Example | A | | 94.3 | | 2.5 | | | 3.2 | 1.0 | | CXC-1614 | 0.5 |
| 1-15 | | | | | | | | | | | | |
| Example | A | | 94.3 | | 2.5 | | | 3.2 | 1.0 | | CXC-1614 | 1.0 |
| 1-16 | | | | | | | | | | | | |
| Example | B | | 94.3 | | 2.5 | | | 3.2 | 1.0 | | CXC-1614 | 3.0 |
| 1-17 | | | | | | | | | | | | |
| Comp. | B | 92.5 | | 7.5 | | | | | 0.8 | | CXC-1614 | 0.5 |
| Example | | | | | | | | | | | | |
| 1-1 | | | | | | | | | | | | |
| Comp. | B | 98.0 | | | 2.0 | | | | 0.8 | | CXC-1614 | 7.0 |
| Example | | | | | | | | | | | | |
| 1-2 | | | | | | | | | | | | |

Manufacturing of Charging Roller 10

The prepared coating liquid was applied onto the surface of the conductive base A or the conductive base B by a roll coating method, to form a coated film. After the coated film was formed, the coated film was cured either by being heated under a condition shown in Table 2 in a case of using the thermal-acid generating agent as the acid generating agent, or by being irradiated with light under a condition shown in Table 2 with a UV irradiation device including a UV-LED light source (manufactured by Heraeus K.K.) in a case of using the photo-acid generating agent as the acid generating agent. Accordingly, the coating layer 4 having a layer thickness shown in Table 2 was formed.

TABLE 2

| | Curing method | | | | |
|---|---|---|---|---|---|
| | UV-LED | | | | CT layer |
| | Wave- | Cumulative | Thermal curing | | Layer |
| | length | light amount | Temperature | Time | thickness |
| | [nm] | [mJ/cm²] | [° C.] | [min] | [um] |
| Example 1-1 | 365 | 5000 | | | 30 |
| Example 1-2 | 365 | 9000 | | | 70 |
| Example 1-3 | 365 | 9000 | | | 140 |
| Example 1-4 | 365 | 15000 | | | 250 |
| Example 1-5 | 405 | 5000 | | | 50 |
| Example 1-6 | 405 | 9000 | | | 90 |
| Example 1-7 | 405 | 9000 | | | 150 |
| Example 1-8 | 405 | 15000 | | | 250 |
| Example 1-9 | | | 200 | 5 | 50 |
| Example 1-10 | | | 200 | 3 | 90 |
| Example 1-11 | | | 200 | 2 | 150 |
| Example 1-12 | | | 160 | 30 | 50 |
| Example 1-13 | | | 160 | 10 | 90 |
| Example 1-14 | | | 160 | 5 | 150 |
| Example 1-15 | | | 130 | 30 | 50 |
| Example 1-16 | | | 130 | 10 | 90 |
| Example 1-17 | | | 130 | 5 | 150 |
| Comparative | | | 130 | 5 | 30 |
| Example 1-1 | | | | | |
| Comparative | | | 130 | 5 | 350 |
| Example 1-2 | | | | | |

By the operation described above, the charging roller 10 including the axis body (the conductive support 1), the elastic layer 2 formed along the outer circumferential surface of the axis body, the resin layer 3 formed along the outer circumferential surface of the elastic layer 2, and the coating layer 4 formed along the outer circumferential surface of the resin layer 3 was prepared. In Examples 1-1 to 1-17, the coating liquid contains the hydrolyzable silane and the zirconium chelate compound, and thus, the coating layer 4 of Examples 1-1 to 1-17 contains a polysiloxane compound having an Si—O—Zr bond in the molecular structure.

Measurement of Surface Free Energy

A contact angle θ of the outermost surface of the charging roller 10 (the surface of the coating layer 4) with respect to three types of probe liquids shown in Table 3 below was measured by using a contact angle meter (Product Name: CA-X ROLL Type, manufactured by Kyowa Interface Science, Inc.). Measurement conditions of the contact angle were as follows.

Measurement Conditions:

Measurement: Liquid Droplet Method (True Circle Fitting)

Flow Rate: 1 μL

Droplet Landing Recognition: Automatic

Image Treatment: Algorithm—No Reflection

Image Mode: Frame

Threshold Level: Automatic

TABLE 3

| | Surface free energy value at 20° C. | | | |
|---|---|---|---|---|
| | (mJ/m²) | | | |
| Probe liquid | γL^{d} | γL^{p} | γL^{h} | γL^{Total} |
| Water | 29.1 | 1.3 | 42.4 | 72.8 |
| Diiodomethane | 46.8 | 4 | 0 | 50.8 |
| Ethylene glycol | 30.1 | 0 | 17.6 | 47.7 |

In Table 3 above, γ_{L}^{d}, γ_{L}^{p}, and γ_{L}^{h} respectively indicate a dispersion component, a dipole component, and a hydrogen-bond component in a probe liquid. Each of components (γ_{L}^{d}, γ_{L}^{p}, and γ_{L}^{h}) of three types of probe liquids in Table 3, and a contact angle θ with respect to each of the probe liquids obtained by measurement were assigned to the following theoretical equation (Calculation Formula (1)) of Kitazaki and Hata, three equations with respect to each of the probe liquids were created, and such simultaneous equations with 3 variables were resolved, in order to calculate the dispersion component (γ_{S}^{d}), the dipole component (γ_{S}^{p}), and the hydrogen-bond component (γ_{S}^{h}) in the coating layer 4. Then, a sum of γ_{S}^{d}, γ_{S}^{p}, and γ_{S}^{h} was set to surface free energy (γ_{S}^{Total}). The results are shown in Table 4.

$$\begin{matrix}Calculation Formula ( 1 ) & \\ \sqrt{{γ}_{L}^{d} \times {γ}_{S}^{d}} + \sqrt{{γ}_{L}^{p} \times {γ}_{S}^{p}} + \sqrt{{γ}_{L}^{h} \times {γ}_{S}^{h}} = \frac{{γ}_{L} ( l + cos θ )}{2} & [ Expression 1 ]\end{matrix}$$

Evaluation of Surface Contamination

The charging member obtained as described above was incorporated in Multixpress C8640 ND manufactured by Samsung Electronics Co., Ltd., to obtain an image forming apparatus, and an image was formed in accordance with the following conditions.

Imaging Conditions:
Printing Environment: in Low Temperature Low Humidity Environment (15° C./10% RH)
Printing Condition: General Printing Speed of 305 mm/sec and Half Speed thereof, Number of Printed Sheets (80 kPV), Type of Sheet

### (Office Paper EC)

Load with respect to Conductive Support End Portion: 5.88 N on One Side
Applied Bias: Suitably adjusted and Determined such that Photoreceptor Surface Potential Reaches −600 V

Next, a surface contamination of the charging roller 10 after the image was formed was evaluated. The surface contamination of the charging roller 10 was mainly derived from silica of an external additive to be used in a toner, and thus, the degree of contamination was evaluated by quantifying an element Si on the surface of the charging roller 10 with a fluorescence X-ray measurement device (EDXL300: manufactured by Rigaku Corporation). Specifically, in a chamber of the fluorescence X-ray measurement device, the charging roller 10 was arranged such that the center of the charging roller 10 was aligned with a detector, and the element Si on the surface of the charging roller 10 was quantified. Such measurement was performed with respect to each of the charging roller 10 before the image was formed and the charging roller 10 after the image was formed (for each 20 kPV), to obtain a difference ΔSi [cps/mA] in the amount of Si (e.g., ΔSi=Amount of Si [cps/mA] after Endurance Test−Amount of Si [cps/mA] before Endurance Test). Next, the difference ΔSi was plotted on a vertical axis, the total number of rotations of the photoreceptor was plotted on a horizontal axis, and the surface contamination was evaluated by using the slope of the obtained graph as an index. The difference ΔSi decreases in proportion to the number of rotations of the photoreceptor as the slope decreases, and the contamination due to the external additive is less likely to occur. The results are shown in Table 4.

TABLE 4

| | Surface free energy | | |
|---|---|---|---|
| | γs^{Total} | γs^{p} + γs^{h} | Endurability |
| | [mJ/m²] | [mJ/m²] | Slope |
| Example 1-1 | 15.0 | 0.0 | 1.34 |
| Example 1-2 | 19.0 | 4.0 | 2.68 |
| Example 1-3 | 23.0 | 8.0 | 3.23 |
| Example 1-4 | 27.0 | 12.0 | 3.66 |
| Example 1-5 | 20.0 | 0.0 | 1.74 |
| Example 1-6 | 22.0 | 2.0 | 2.69 |
| Example 1-7 | 28.0 | 8.0 | 3.63 |
| Example 1-8 | 30.0 | 10.0 | 3.85 |
| Example 1-9 | 22.0 | 0.0 | 1.89 |
| Example 1-10 | 29.0 | 7.0 | 3.66 |
| Example 1-11 | 32.0 | 10.0 | 4.00 |
| Example 1-12 | 25.0 | 0.0 | 2.09 |
| Example 1-13 | 30.0 | 5.0 | 3.59 |
| Example 1-14 | 33.0 | 8.0 | 3.98 |
| Example 1-15 | 30.0 | 0.0 | 2.41 |
| Example 1-16 | 32.0 | 2.0 | 3.36 |
| Example 1-17 | 35.0 | 5.0 | 3.91 |
| Comparative Example 1-1 | 37.0 | 15.0 | 4.47 |
| Comparative Example 1-2 | 45.0 | 15.0 | 5.00 |

As described above, in the charging roller 10 of Example 1-1 to Example 1-17, the surface free energy (γ_{S}^{Total}) of the coating layer 4 is 35.0 mJ/m² or less, and a sum of the dipole component (γ_{S}^{p}) and the hydrogen-bond component (γ_{S}^{h}) of the surface free energy of the coating layer 4 is 12.0 mJ/m² or less. It is observed that in the charging roller 10 of Example 1-1 to Example 1-17, the slope of the graph to be obtained from ΔSi and the total number of rotations of the photoreceptor is relatively low, and the surface contamination due to the external additive is suppressed, compared to Comparative Examples 1-1 to 1-3.

### Examples 2-1 to 1-17 and Comparative Examples 2-1 to 2-3

A hydrolyzable silane compound containing epoxy (hydrolyzable silane E), a one end-modified silicone compound (silicone E), a hydrolyzable silane compound having an isocyanate group (hydrolyzable silane I), a zirconium chelate compound in accordance with a case, and a solvent (water and ethanol), shown in Table 5, were mixed, and then, were stirred at a room temperature, and then, were heated to reflux for 24 hours, in order to obtain a condensate of hydrolyzable silane having a silicone skeleton. The condensate was added to a mixed solvent of 2-butanol/ethanol, and thus, a condensate-containing alcohol solution having a solid content shown in Table 5 was prepared. At this time, curable components (the hydrolyzable silane E, the silicone E, the hydrolyzable silane I, and the zirconium chelate compound) were compounded at a compounding ratio shown in Table 5 such that the total amount was 100 mol %. In addition, a compounding amount of water was adjusted such that R_{OR} had a value shown in Table 5. Next, 0.35 g of an acid generating agent shown in Table 5 was added to 100 g of the condensate-containing alcohol solution, and thus, a coating liquid was prepared. The details of the compounds not shown in Table 1 but shown in Table 5 are as follows.

MCR-E11: Product Name (Manufactured by Gelest, Inc.), One End-Modified Silicone (Viscosity of 10 mm²/s(25° C.) to 15 mm²/s(25° C.), Functional Group Equivalent of 1000 glmol)

X-22-173BX: Product Name (manufactured by Shin-Etsu Chemical Co., Ltd.), One End-Modified Silicone (Viscosity of 30 mm²/s(25° C.), Functional Group Equivalent of 2500 g/mol)

X-22-173DX: Product Name (manufactured by Shin-Etsu Chemical Co., Ltd.), One End-Modified Silicone (Viscosity of 60 mm²/s(25° C.), Functional Group Equivalent of 4600 g/mol)

KBE-9007N: Product Name (manufactured by Shin-Etsu Chemical Co., Ltd.), 3-Isocyanate Propyl Triethoxysilane

TAG-2700: Product Name (manufactured by Kusumoto Chemicals, Ltd. Quaternary Ammonium Salt-Based Thermal-Acid Generating Agent

TAG-2690: Product Name (manufactured by Kusumoto Chemicals, Ltd.), Quaternary Ammonium Salt-Based Thermal-Acid Generating Agent

TAG-2689: Product Name (manufactured by Kusumoto Chemicals, Ltd.), Quaternary Ammonium Salt-Based Thermal-Acid Generating Agent

TABLE 5

| | | | | Silicone E | | | Hydrolyzable |
|---|---|---|---|---|---|---|---|
| | Conduc- | Hydrolyzable silane E | | | X-22-173 | X-22-173 | silane I |
| | tive | KBM-403 | KBM-303 | MCR-E11 | BX | DX | KBE-9007N |
| | base | [mol %] | [mol %] | [mol %] | [mol %] | [mol %] | [mol %] |
| Example | A | 92.9 | | 0.1 | | | 1.0 |
| 2-1 | | | | | | | |
| Example | A | 92.5 | | 0.5 | | | 1.0 |
| 2-2 | | | | | | | |
| Example | B | 92.0 | | 1.0 | | | 1.0 |
| 2-3 | | | | | | | |
| Example | A | | 93.5 | | 0.2 | | 1.5 |
| 2-4 | | | | | | | |
| Example | B | | 92.9 | | 0.8 | | 1.5 |
| 2-5 | | | | | | | |
| Example | A | 94.5 | | | | 0.3 | 2.0 |
| 2-6 | | | | | | | |
| Example | B | 94.1 | | | | 0.7 | 2.0 |
| 2-7 | | | | | | | |
| Example | A | | 90.9 | 0.1 | | | 3.0 |
| 2-8 | | | | | | | |
| Example | A | 93.3 | | | | 0.5 | 3.0 |
| 2-9 | | | | | | | |
| Example | B | | 90.0 | 1.0 | | | 3.0 |
| 2-10 | | | | | | | |
| Example | A | 93.0 | | | | 0.3 | 3.5 |
| 2-11 | | | | | | | |
| Example | B | 92.6 | | | | 0.7 | 3.5 |
| 2-12 | | | | | | | |
| Example | A | | 91.0 | | 0.2 | | 4.0 |
| 2-13 | | | | | | | |
| Example | B | | 90.4 | | 0.8 | | 4.0 |
| 2-14 | | | | | | | |
| Example | A | 88.9 | | 0.1 | | | 5.0 |
| 2-15 | | | | | | | |
| Example | A | 88.5 | | 0.5 | | | 5.0 |
| 2-16 | | | | | | | |
| Example | B | 88.0 | | 1.0 | | | 5.0 |
| 2-17 | | | | | | | |
| Comp. | B | 98.8 | | 1.2 | | | 0.0 |
| Example | | | | | | | |
| 2-1 | | | | | | | |
| Comp. | A | 94.0 | | 0.0 | | | 6.0 |
| Example | | | | | | | |
| 2-2 | | | | | | | |
| Comp. | B | 92.8 | | 1.2 | | | 6.0 |
| Example | | | | | | | |
| 2-3 | | | | | | | |
| | Zr chelate compound | | | | Acid generating | | Solid |
| | AKZ947 | ZC-580 | ZC-540 | | agent | | content |
| | [mol %] | [mol %] | [mol %] | R_{OR} | Light | Heat | [mass %] |
| Example | 6.0 | | | 1.5 | | TAG- | 0.5 |
| 2-1 | | | | | | 2700 | |
| Example | 6.0 | | | 1.5 | | TAG- | 3.0 |
| 2-2 | | | | | | 2700 | |
| Example | 6.0 | | | 1.5 | | TAG- | 5.0 |
| 2-3 | | | | | | 2700 | |
| Example | | 4.8 | | 1.5 | CPI-310S | | 1.0 |
| 2-4 | | | | | | | |
| Example | | 4.8 | | 1.5 | CPI-310S | | 4.0 |
| 2-5 | | | | | | | |
| Example | | | 3.2 | 1.2 | CPI-410S | | 2.0 |
| 2-6 | | | | | | | |
| Example | | | 3.2 | 1.2 | CPI-410S | | 4.0 |
| 2-7 | | | | | | | |
| Example | | | 6.0 | 1.2 | | TAG- | 0.5 |
| 2-8 | | | | | | 2690 | |
| Example | | | 3.2 | 1.2 | CPI-410S | | 3.0 |
| 2-9 | | | | | | | |
| Example | | | 6.0 | 1.2 | | TAG- | 5.0 |
| 2-10 | | | | | | 2690 | |
| Example | | | 3.2 | 1.2 | CPI-410S | | 2.0 |
| 2-11 | | | | | | | |
| Example | | | 3.2 | 1.2 | CPI-410S | | 4.0 |
| 2-12 | | | | | | | |
| Example | | 4.8 | | 1.0 | CPI-310S | | 1.0 |
| 2-13 | | | | | | | |
| Example | | 4.8 | | 1.0 | CPI-310S | | 4.0 |
| 2-14 | | | | | | | |
| Example | 6.0 | | | 1.0 | | TAG- | 0.5 |
| 2-15 | | | | | | 2689 | |
| Example | 6.0 | | | 1.0 | | TAG- | 3.0 |
| 2-16 | | | | | | 2689 | |
| Example | 6.0 | | | 1.0 | | TAG- | 5.0 |
| 2-17 | | | | | | 2689 | |
| Comp. | | | | 0.8 | | TAG- | 0.5 |
| Example | | | | | | 2689 | |
| 2-1 | | | | | | | |
| Comp. | | | | 2.0 | CPI-310S | | 7.0 |
| Example | | | | | | | |
| 2-2 | | | | | | | |
| Comp. | | | | 2.0 | | TAG- | 7.0 |
| Example | | | | | | 2689 | |
| 2-3 | | | | | | | |

Manufacturing of Charging Member

The coating layer 4 having a layer thickness shown in Table 6 was formed as with Example 1-1 or the like, except that the coating liquid prepared as described above was used, and the coated film was cured under a condition shown in Table 6. Accordingly, the charging roller 10 including the axis body (the conductive support 1), the elastic layer 2 formed along the outer circumferential surface of the axis body, the resin layer 3 formed along the outer circumferential surface of the elastic layer 2, and the coating layer 4 formed along the outer circumferential surface of the resin layer 3 was prepared. In Examples 2-1 to 2-17, the coating liquid contains the hydrolyzable silane and the zirconium chelate compound, and thus, the coating layer 4 of Examples 2-1 to 2-17 contains a polysiloxane compound having an Si—O—Zr bond in the molecular structure.

TABLE 6

| | Curing method | | | | |
|---|---|---|---|---|---|
| | UV-LED | | | | CT layer |
| | Wave- | Cumulative | Thermal curing | | Layer |
| | length | light amount | Temperature | Time | thickness |
| | [nm] | [mJ/cm²] | [° C.] | [min] | [μm] |
| Example 2-1 | | | 130 | 5 | 40 |
| Example 2-2 | | | 130 | 10 | 240 |
| Example 2-3 | | | 130 | 30 | 400 |
| Example 2-4 | 365 | 5000 | | | 80 |
| Example 2-5 | 365 | 5000 | | | 320 |
| Example 2-6 | 365/405 | 5000 | | | 160 |
| Example 2-7 | 365/405 | 5000 | | | 320 |
| Example 2-8 | | | 200 | 3 | 40 |
| Example 2-9 | 365/405 | 9000 | | | 240 |
| Example 2-10 | | | 200 | 5 | 400 |
| Example 2-11 | 365/405 | 15000 | | | 160 |
| Example 2-12 | 365/405 | 15000 | | | 320 |
| Example 2-13 | 365 | 15000 | | | 80 |
| Example 2-14 | 365 | 15000 | | | 320 |
| Example 2-15 | | | 160 | 5 | 40 |
| Example 2-16 | | | 160 | 10 | 240 |
| Example 2-17 | | | 160 | 30 | 400 |
| Comparative | | | 160 | 30 | 40 |
| Example 2-1 | | | | | |
| Comparative | 365 | 2000 | | | 560 |
| Example 2-2 | | | | | |
| Comparative | | | 160 | 30 | 560 |
| Example 2-3 | | | | | |

Evaluation of Phase Separation

The coating layer 4 was visually observed, and the degree of phase separation was evaluated based on the following standards. Results are shown in Table 7. Incidentally, the subsequent evaluation was not performed for example evaluated as D.

Evaluation A: Uniform Dispersion Was Performed without Phase Separation

Evaluation B: Stable Dispersion Was Performed in Emulsion State Even after Still Standing for 24 h.

Evaluation C: Emulsion State Was Obtained Immediately after Still Standing, but Phase Separation was Checked after Still Standing for 24 h

Evaluation D: Phase Separation Occurred Immediately after Still Standing.

Evaluation of Surface Frictional Force

The coating liquid prepared as described above was applied onto an aluminum sheet having a thickness of 0.1 mm by using a spin coater (ASC150II, manufactured by ASUMI GIKEN, Limited), and then, was cured in the same condition as that of each of the Examples and Comparative Examples, so as to form a coating layer having a thickness of 30 mm to 400 mm. After that, a surface frictional force was measured in a condition of a load of 25 g and 0.1 mm/sec, by HEIDON Type-38 (manufactured by Shinto Scientific Co., Ltd.; Continuous Load Type). Results are shown in Table 7.

Evaluation of Surface Contamination

The surface contamination of the charging roller 10 was evaluated as with Example 1-1 or the like. Results are shown in Table 7.

TABLE 7

| | Evaluation | Surface frictional | |
|---|---|---|---|
| | of phase | force [N] of CT | Endurability |
| | separation | layer at 25 g | Slope |
| Example 2-1 | C | 0.035 | 2.30 |
| Example 2-2 | C | 0.035 | 2.30 |
| Example 2-3 | C | 0.035 | 2.30 |
| Example 2-4 | B | 0.027 | 1.75 |
| Example 2-5 | B | 0.027 | 1.75 |
| Example 2-6 | A | 0.022 | 1.45 |
| Example 2-7 | A | 0.022 | 1.45 |
| Example 2-8 | A | 0.038 | 2.50 |
| Example 2-9 | A | 0.023 | 1.52 |
| Example 2-10 | A | 0.038 | 2.50 |
| Example 2-11 | A | 0.024 | 1.55 |
| Example 2-12 | A | 0.024 | 1.55 |
| Example 2-13 | A | 0.029 | 1.91 |
| Example 2-14 | A | 0.029 | 1.91 |
| Example 2-15 | A | 0.040 | 2.63 |
| Example 2-16 | A | 0.040 | 2.63 |
| Example 2-17 | A | 0.040 | 2.63 |
| Comparative Example 2-1 | D | — | — |
| Comparative Example 2-2 | A | 0.071 | 4.66 |
| Comparative Example 2-3 | A | 0.066 | 4.34 |

As described above, in the charging roper 10 of Example 2-1 to Example 2-17, the surface frictional force of the coating layer 4 is 0.040 N or less. Then, it is found that in the charging roller 10 of Example 2-1 to Example 2-17, the slope of the graph to be obtained from ΔSi and the total number of rotations of the photoreceptor is small, and the surface contamination due to the external additive is suppressed, compared to Comparative Example 2-1 to 2-3.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

1. A charging member comprising:
a conductive support; and
a conductive body mounted on the conductive support, wherein the conductive body includes:
an elastic layer located on the conductive support,
a resin layer located on the elastic layer, and
a coating layer located on the resin layer to form an outermost surface of the conductive body,
wherein the coating layer contains a polysiloxane compound having a molecular structure that includes an Si—O—Zr bond.

2. The charging member according to claim 1,
wherein the polysiloxane compound has a cross-linking structure derived from an epoxy group.

3. The charging member according to claim 1,
wherein the polysiloxane compound has a perfluoroalkyl group.

4. The charging member according to claim 1,
wherein the polysiloxane compound has a structure represented by Formula (9) below 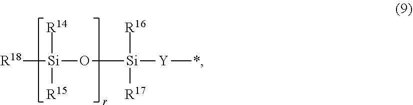
wherein R¹⁴ to R¹⁸ each independently indicate an alkyl group having 1 to 4 carbon atoms, r indicates an integer of 10 to 100, Y indicates a divalent organic group, and * indicates a bonding hand with respect to Si.

5. The charging member according to claim 4,
wherein Yin Formula (9) has an oxazolidone ring in a main chain.

6. The charging member according to claim 1,
wherein a surface free energy of the coating layer is 35.0 mJ/m² or less, and a sum of a dipole component and a hydrogen-bond component of the surface free energy of the coating layer is 12.0 mJ/m² or less.

7. The charging member according to claim 1,
wherein a surface frictional force of the coating layer is 0.040 N or less.

8. A manufacturing method of a charging member, the method comprising:
applying a coating liquid onto a surface of a conductive base that is mountable on a conductive support,
wherein the conductive base includes an elastic layer, and a resin layer that is formed on the elastic layer and includes the surface to be coated, and
wherein the coating liquid includes a composition containing a hydrolyzable silane compound and a zirconium chelate compound; and
curing the composition to form a coating layer over the conductive base.

9. The manufacturing method of a charging member according to claim 8,
wherein the composition contains a hydrolyzable silane compound having an epoxy group and an acid generating agent.

10. The manufacturing method of a charging member according to claim 9,
wherein the acid generating agent is a photo-acid generating agent, and
wherein the curing comprises irradiating the composition with light having a wavelength of 365 nm to 405 nm from a UV-LED fight source.

11. The manufacturing method of a charging member according to claim 9,
wherein the acid generating agent is a thermal-acid generating agent, and
wherein the curing comprises heating the composition at 250° C. or less.

12. The manufacturing method of a charging member according to claim 8,
wherein the composition contains a hydrolyzable silane compound having a perfluoroalkyl group.

13. The manufacturing method of a charging member according to claim 8,
wherein the composition contains;
a one end-modified silicone compound having a structure represented by Formula (16) below 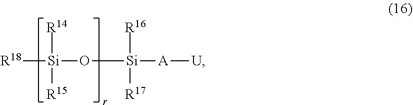
wherein, R¹⁴ to R¹⁸ each independently indicate an alkyl group having 1 to 4 carbon atoms, r indicates an integer of 10 to 100, A indicates a single bond or a divalent organic group, and U indicates a reactive group; and.
a hydrolyzable silane compound having a functional group capable of forming a bond by reacting with a reactive group of the one end-modified silicone compound.

14. The manufacturing method of a charging member according to claim 13,
wherein the reactive group is an epoxy group, and the functional group is an isocyanate group.

15. An image forming apparatus, comprising:
a photoreceptor; and
a charging member to charge the photoreceptor, wherein the charging member includes:
a conductive support, and
a conductive body mounted on the conductive support, wherein the conductive body includes:
an elastic layer located on the conductive support,
a resin layer located on the elastic layer, and
a coating layer located on the resin layer to form an outermost surface of the conductive body, wherein the coating layer contains a polysiloxane compound having molecular structure that includes an Si—O—Zr bond.
